(19) United States
(12) Patent Application Publication
(10) Pub. No.: US 2005/0240884 A1
(43) Pub. Date: Oct. 27, 2005

(54) VIA SPACING VIOLATION CORRECTION METHOD, SYSTEM AND PROGRAM PRODUCT

(75) Inventors: Terry L. Frederick, Milton, VT (US); Jason D. Hibbeler, Williston, VT (US); Kevin W. McCullen, Essex Junction, VT (US); William F. Pokorny, Mansfield, PA (US)

Correspondence Address: HOFFMAN WARNICK & D'ALESSANDRO, LLC, 75 STATE STREET, 14TH FL, ALBANY, NY, 12207, US

(73) Assignee: INTERNATIONAL BUSINESS MACHINES CORPORATION, Armonk, NY (US)

(21) Appl. No.: 10/709,294

(22) Filed: Apr. 27, 2004

(51) Int. Cl. G06F 17/50; G06F 9/45

(52) U.S. Cl. 716/2; 716/5

(57) ABSTRACT

A method, system and program product for correcting via spacing violations by generating a redundant via to replace one of a pair of vias that violate a ground rule, are disclosed. The redundant via corrects the ground rule violation. The target via corresponding to the redundant via is then removed, which corrects the ground rule violation. The invention can be applied to any spacing ground rule including same net and different net rules, and may also be applied to a current technology or, during migration, to a new technology. The invention can be applied to different levels of a design to ensure ground rule compliance throughout the design.

### BACKGROUND OF INVENTION

1. Technical Field

The present invention relates generally to integrated circuit (IC) design, and more particularly to a method, system and program product for correcting via spacing violations in an IC design.

2. Related Art

When migrating an existing very large scale integrated (VLSI) circuit physical design from one technology to another, it is sometimes necessary to enforce different spacing ground rules for contact vias. For example, spacing for vias that are on different electrical nets may be larger than the corresponding via spacing for vias on the same net.

One possible approach for making these modifications between nets is by using an automatic layout-migration program. A drawback to this approach, however, is that most compaction-based layout-migration tools work in one axis at a time. That is, they form constraints in the horizontal direction and then move shapes in the horizontal direction; then they build constraints and move shapes in the vertical direction. Unfortunately, it is frequently the case that, for a certain pair of vias, the spacing violation exists in one direction, but the only way to resolve the problem is in the perpendicular direction. Compaction-based techniques cannot easily handle this situation.

Another limitation of the above-identified approach relates to data volume. In particular, changes necessary to correct spacing violations for vias are oftentimes chip-wide in nature and potentially involve all of the back-end-of-line (BEOL) levels. As a consequence, the amount of data requiring correction can be immense, which results in the corrections being time and resource consuming. Furthermore, correcting spacing problems manually is tedious and potentially intractable because of scheduling requirements.

In view of the foregoing, there is a need in the art for a way to correct spacing problems that does not suffer from the problems of the related art.

### SUMMARY OF INVENTION

The invention includes a method, system and program product for correcting via spacing violations by generating a redundant via to replace one of a pair of vias that violate a ground rule. The redundant via corrects the ground rule violation. The target via corresponding to the redundant via is then removed, which corrects the ground rule violation. The invention can be applied to any spacing ground rule including same net and different net rules, and may also be applied to a current technology or, during migration, to a new technology. The invention can be applied to different levels of a design to ensure ground rule compliance throughout the design.

A first aspect of the invention is directed to a method for correcting a ground rule violation for a target via pair in a design, the method comprising the steps of: generating a redundant via for a target via of the target via pair where the redundant via corrects the ground rule violation; and removing the target via corresponding to the redundant via to correct the ground rule violation.

A second aspect of the invention is directed to a system for correcting a ground rule violation for a target via pair in a design, the method comprising the steps of: means for generating a redundant via for a target via of the target via pair where the redundant via corrects the ground rule violation; and means for removing the target via corresponding to the redundant via to correct the ground rule violation.

A third aspect of the invention is directed to a computer program product comprising a computer useable medium having computer readable program code embodied therein for correcting a ground rule violation for a target via pair in a design, the program product comprising: program code configured to generate a redundant via for a target via of the target via pair where the redundant via corrects the ground rule violation; and program code configured to remove the target via corresponding to the redundant via to correct the ground rule violation.

The foregoing and other features of the invention will be apparent from the following more particular description of embodiments of the invention.

### BRIEF DESCRIPTION OF DRAWINGS

The embodiments of this invention will be described in detail, with reference to the following figures, wherein like designations denote like elements, and wherein:

FIG. 1 shows a portion of an integrated circuit illustrating vias and related structure including a ground rule violation to be solved by the invention.

FIG. 2 shows a block diagram of a correction system for correcting a ground rule violation according to the invention.

FIG. 3 shows a flow diagram of the methodology for correcting a ground rule violation.

FIG. 4 shows one step of the method in which target vias of FIG. 1 are marked.

FIG. 5 shows another step of the method in which a redundant via is generated relative to the structure of FIG. 1.

FIG. 6 shows another step of the method in which the ground rule violation is corrected in the structure of FIG. 1.

### DETAILED DESCRIPTION

The invention includes a method, system and program product for correcting ground rule violations for a structure in an integrated circuit (IC). For purposes of description, the invention will be described in terms of correcting spacing violations for contact vias. It should be recognized, however, that the invention may be applied to other structures in which ground rules are violated.

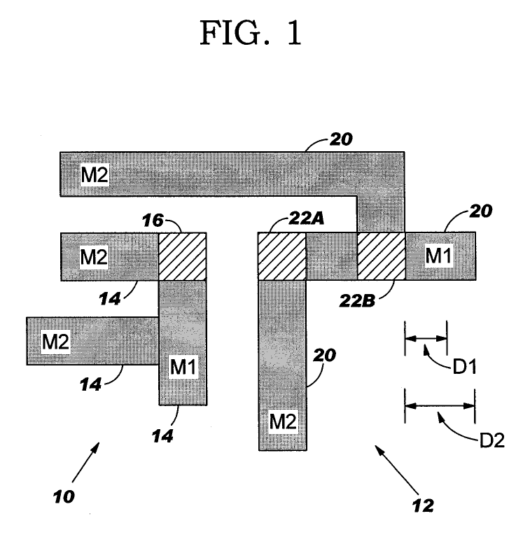

With reference to the accompanying drawings, FIG. 1 shows a situation illustrating the problem to be addressed by the invention. FIG. 1 illustrates structures of a first net level 10 and a second, different net level 12. First net level 10 includes wiring 14 of different illustrative metal layers M1, M2 and an illustrative structure 16 in the form of a via. Similarly, second net level 12 includes wiring 20 of different illustrative metal layers M1, M2 and two illustrative structures 22A, 22B in the form of vias. In terms of ground rules, a ground rule spacing requirement for vias of the same-net is shown as D1. This rule mandates that vias on the same net, such as vias 22A, 22B of second net 12, have at least the spacing shown by D1. A ground rule spacing requirement for vias of different-nets is shown as D2. This rule mandates that vias on different nets, such as via 22A of second net 12 and via 16 of first net 10, have at least the spacing shown by D2. As illustrated in FIG. 1, however, via 22A and via 16 violate this different-net ground rule, i.e., they are too close together.

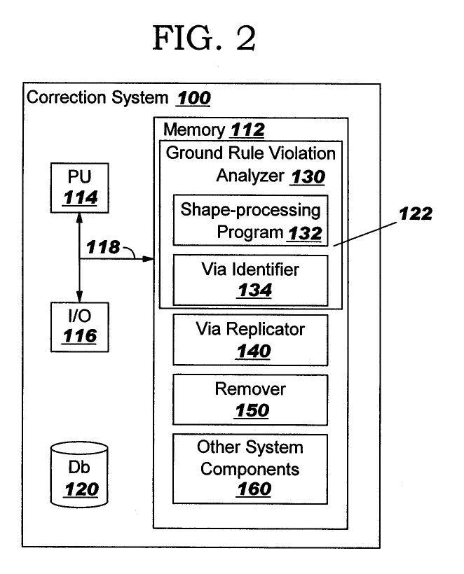

Turning to FIG. 2, a block diagram of a correction system 100 in accordance with the invention is shown. Correction system 100 includes a memory 112, a processing unit (PU) 114, input/output devices (I/O) 116 and a bus 118. A database 120 may also be provided for storage of data relative to processing tasks. Memory 112 includes a program product 122 that, when executed by PU 114, comprises various functional capabilities described in further detail below. Memory 112 (and database 120) may comprise any known type of data storage system and/or transmission media, including magnetic media, optical media, random access memory (RAM), read only memory (ROM), a data object, etc. Moreover, memory 112 (and database 120) may reside at a single physical location comprising one or more types of data storage, or be distributed across a plurality of physical systems. PU 114 may likewise comprise a single processing unit, or a plurality of processing units distributed across one or more locations. I/O 116 may comprise any known type of input/output device including a network system, modem, keyboard, mouse, scanner, voice recognition system, CRT, printer, disc drives, etc. Additional components, such as cache memory, communication systems, system software, etc., may also be incorporated into system 100.

As shown in FIG. 2, program product 122 may include: a ground rule violation analyzer 130 including shape-processing program 132 and a via identifier 134; a via replicator 140; a remover 150; and other system components 160.

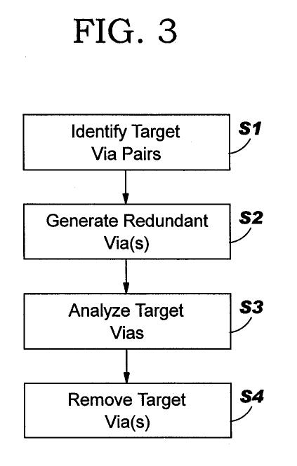

Turning to FIG. 3, a flow diagram of operational methodology of system 100 is illustrated.

In a first step S1, target via pairs are identified that violate a ground rule by ground rule violation analyzer 130. In one embodiment, ground rule violation analyzer 130 includes any now known or later developed shape-processing program 132 that can determine a ground rule violation, and a via identifier 134 according to the invention that distinguishes via pairs that violate a ground rule from other structure. The term “target” is applied to via pairs, and vias thereof, since they violate a ground rule and are targeted for correction. It should be recognized that shape-processing program 132 evaluates any ground rules regardless of whether they are applicable to the same net or a different net. In addition, shape-processing program 132 may also be applied to any ground rule involving pairs of vias of contacts, such as density rules. In addition, the invention is also applicable where migrating from one technology to another. In this case, shape-processing program 132 also may enforce ground rules for the new technology, in particular the spacing ground rules for the new technology.

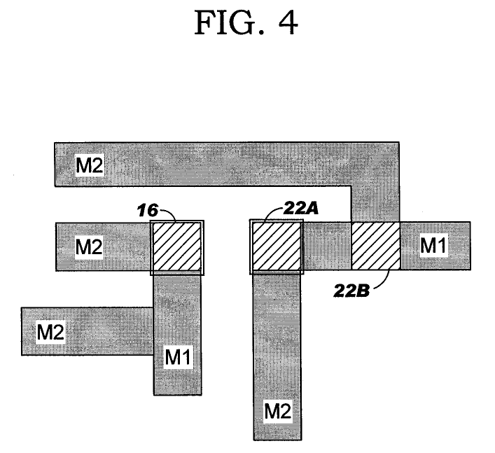

FIG. 4 illustrates the structure of FIG. 1, including a different-net ground rule violation by target via pair 16 and 22A. Target vias 16, 22A are distinguished by via identifier 134 by some mechanism that makes them stand out relative to other structure. For example, target vias 16, 22A may be marked with different colors in a design system viewer, or as shown in FIG. 4, target vias 16, 22A may each be marked by a box outlining the target via. In one embodiment, the particular markings used may indicate which ground rule is violated, e.g., current same net, current different net, new same net, new different net, etc.

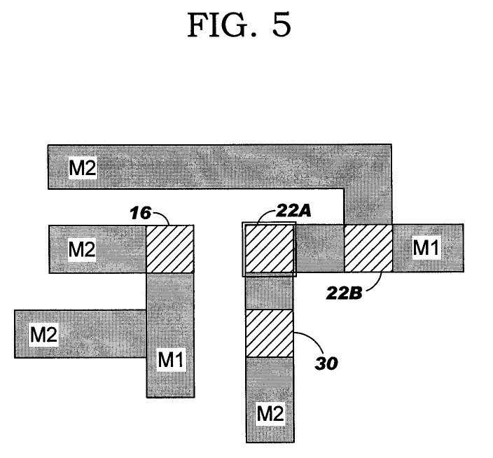

In step S2, a redundant via is generated by via replicator 140 for each target via where the redundant via corrects a ground rule violation. Those target vias that violate a ground rule, but for which a redundant via cannot be generated that corrects the ground rule violation are left alone. In FIG. 5, a redundant via 30 for target via 22A only has been generated. Via replicator 140 generates redundant vias that obey all of the relevant ground rules in a current technology. In addition, where the invention is applied to technology migration, via replicator 140 generates redundant vias that obey ground rules for the new technology, in particular the via-spacing ground rules for the new technology.

In step S3, the results of the redundant via generation in step S2 are analyzed by shape-processing program 132 to identify which target vias 16, 22A acquired a redundant via 30. Those target vias 22A, as shown in FIG. 5, that acquired a redundant via 30 are distinguished by via identifier 134 by some mechanism that makes them stand out relative to other structure. For example, target via 22A may be marked with different colors in a design system viewer, or as shown in FIG. 5, target via 22A may be marked by a box outlining the via. The particular markings used may indicate which ground rule is corrected, e.g., current same net, current different net, new same net, new different net, etc.

In step S4, original target vias corresponding to redundant vias distinguished in step S3 are removed by remover 150. In one embodiment, remover 150 uses a batch-mode layout-editing program that removes a corresponding target via 22A (FIG. 5) distinguished in step S3. If both target vias in a target via pair from step S1 acquired a new redundant via (e.g., target via 16 in FIG. 5 also acquired a redundant via) remover 150 only removes one of the target vias (e.g., target via 22A), with the constraint that the two remaining vias do not violate the ground rule. In addition, remover 150 removes all unused redundant vias, e.g., the redundant via that would have been produced for target via 16).

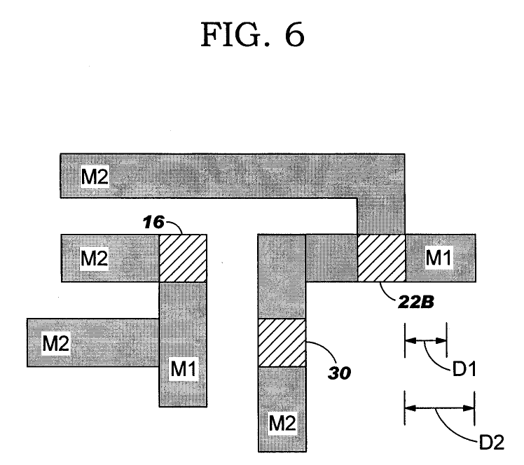

FIG. 6 illustrates the result of the above-described methodology in which ground rule violations have been corrected. Target via 22A is now removed, and redundant via 30 constitutes part of the design. As illustrated, all vias 16, 22A, 30 obey ground rules for the same net D1 and different nets D2. As noted above, the invention finds applicability for ground rules of the same net or a different net. In addition, given a physical design to be migrated from one set of manufacturing ground rules to another in which, for example, via-spacing for different-net vias is greater than via spacing for same-net vias, the invention can correct any violations by applying the above methodology to each via level in the design, i.e., the above methodology can be repeated for each via level of a design.

In the previous discussion, it will be understood that the method steps discussed are performed by a processor, such as PU 114 of system 100, executing instructions of program product 122 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A method for correcting a ground rule violation for a target via pair in a design, the method comprising the steps of:
generating a redundant via for a target via of the target via pair where the redundant via corrects the ground rule violation; and
removing the target via corresponding to the redundant via to correct the ground rule violation.

2. The method of claim 1, wherein the generating step includes generating a redundant via for each target via of the target via pair, and the removing step includes removing the redundant via for one of the target vias and removing the redundant via for the other of the target vias.

3. The method of claim 1, further comprising the step of identifying the target via pairs that violate a ground rule prior to the generating step, and distinguishing those target via pairs from other structure.

4. The method of claim 1, further comprising the step of identifying which target vias acquired a redundant via by the generating step prior to the removing step, and distinguishing those target vias from other structure.

5. The method of claim 1, wherein the ground rule is a different-net spacing ground rule.

6. The method of claim 1, wherein the generating step includes generating the redundant structure where no spacing ground rule violation occurs for a new technology.

7. The method of claim 1, further comprising the steps of repeating the generating and removing steps for each level of a design.

8. A system for correcting a ground rule violation for a target via pair in a design, the method comprising the steps of:
means for generating a redundant via for a target via of the target via pair where the redundant via corrects the ground rule violation; and
means for removing the target via corresponding to the redundant via to correct the ground rule violation.

9. The system of claim 8, wherein the generating means includes means for generating a redundant via for each target via of the target via pair, and the removing means includes means for removing the redundant via for one of the target vias and removing the redundant via for the other of the target vias.

10. The system of claim 8, further comprising the means for identifying the target via pairs that violate a ground rule prior to generating the redundant vias, and means for distinguishing those target via pairs from other structure.

11. The system of claim 8, further comprising means for identifying which target vias acquired a redundant via prior to removing the target via, and means for distinguishing those target vias from other structure.

12. The system of claim 8, wherein the ground rule is a different-net spacing ground rule.

13. The system of claim 8, wherein the generating means includes means for generating the redundant structure where no spacing ground rule violation occurs for a new technology.

14. The system of claim 8, further comprising means for repeating the generating and removing steps for each level of a design.

15. A computer program product comprising a computer useable medium having computer readable program code embodied therein for correcting a ground rule violation for a target via pair in a design, the program product comprising:
program code configured to generate a redundant via for a target via of the target via pair where the redundant via corrects the ground rule violation; and
program code configured to remove the target via corresponding to the redundant via to correct the ground rule violation.

16. The program product of claim 15, wherein the generating code includes program code configured to generate a redundant via for each target via of the target via pair, and the removing code includes program code configured to remove the redundant via for one of the target vias and removing the redundant via for the other of the target vias.

17. The program product of claim 15, further comprising the program code configured to identify the target via pairs that violate a ground rule prior to the generating code execution, and program code configured to distinguish those target via pairs from other structure.

18. The program product of claim 15, further comprising program code configured to identify which target vias acquired a redundant via by the generating step prior to the removing code execution, and program code configured to distinguish those target vias from other structure.

19. The program product of claim 15, wherein the ground rule is a different-net spacing ground rule.

20. The program product of claim 15, wherein the generating code includes program code configured to generate the redundant structure where no spacing ground rule violation occurs for a new technology.
